(19) United States
(12) Patent Application Publication
(10) Pub. No.: US 2007/0296112 A1
(43) Pub. Date: Dec. 27, 2007

(54) INTEGRATED BELT PULLER AND THREE-DIMENSIONAL FORMING MACHINE

(75) Inventors: Jeffrey R. Brandt, Millersport, OH (US); Matthew F. Kollar, Powell, OH (US)

Correspondence Address: STANDLEY LAW GROUP LLP, 495 METRO PLACE SOUTH, SUITE 210, DUBLIN, OH, 43017, US

(73) Assignee: Crane Plastics Company LLC, Columbus, OH (US)

(21) Appl. No.: 11/852,271

(22) Filed: Sep. 7, 2007

Related U.S. Application Data
(63) Continuation of application No. 10/954,539, filed on Sep. 30, 2004, now abandoned.

(51) Int. Cl. B29C 67/20

(52) U.S. Cl. 264/175

(57) ABSTRACT

The present invention relates generally to an integrated belt machine. More particularly, the present invention is directed to an integrated belt puller and 3D forming machine for continuously forming 3D products from plastic materials.

This is a continuation of U.S. application Ser. No. 10/954,539, filed Sep. 30, 2004, which is hereby incorporated by reference in its entirety.

### BACKGROUND AND SUMMARY OF THE INVENTION

The present invention relates generally to a three-dimensional belt forming machine. More particularly, the present invention is directed to an integrated belt puller and three-dimensional forming machine for forming three-dimensional products from plastic materials. The plastic materials may include, but are not limited to, polymers (e.g., PP, PE, LDPE, HDPE, EVA, ABS, PVC, and CPVC), thermoplastics, thermosets, composite materials such as cellulosic-filled and/or inorganic-filled plastic composite materials (e.g., cellulosic-filled PVC composites, cellulosic-filled HDPE composites, cellulosic-filled PP composites, etc.), and other types of plastic material. The present invention may be useful for making siding accessories, interior and exterior decorative house moldings, picture frames, furniture components, deck components, deck railings, window moldings, window components, window lineals, door components, roof components, fence components, fence posts, fence rails, floor components, and other suitable indoor and outdoor items from plastic materials. In addition, the plastic material may be used to make other types of products that are commonly made from wood, metal, plastic, or plastic composites.

Historically, wood was the primary raw material to form such products. One reason wood was desired was due to the decorative nature of the grain of wood. One desirable attribute of wood grain was the variation created by its pattern and/or texture. For example, if a piece of siding was made from wood, it would have the two-dimensional shape of the siding as designed. However, the wood siding would also have variation or texture along a third-dimension, i.e., its length, created by the wood grain.

Over the past several years, plastic materials have become a preferred raw material to manufacture the above exemplary building products due to improved life, maintenance requirements, and costs. One method used in the manufacturing of these products is plastic extrusion. Generally, plastic extrusion comprises taking raw material in the form of a plastic resin and placing it into a barrel of an extruder. This extruder heats the resin to the resin's glass transition temperature and then forces the heated resin through a die. The die shapes the plastic material into a continuous two-dimensional profile such as a continuous piece of PVC siding.

Typically, as the heated plastic material exits the extruder, it enters a belt puller. The belt puller consists of two opposed belts that are revolving in opposed relationship along their respective upper and lower oval paths, which pull the heated plastic material into the belt puller from the extruder. In order for the belts to pull the heated plastic material, the plastic material must have cooled enough that it has some structural integrity. If not, the plastic material would just stretch when the belts pull on it, preventing the puller from pulling the plastic from the extruder. The puller also supports the heated material along its length while the material cools and hardens. To date, this type of plastic extrusion system is unable to create a product that can create the variability in the third dimension, i.e., variability in the height along the length of the material, to simulate wood grain.

Some have tried to overcome the problem of plastic extruded products not having the variability along the third-dimension by adding a separate machine that comprises (“3D”) mold belts that form the heated thermoplastic material immediately after it exits the extruder and before it enters the belt puller. The key with these 3D forming systems is that the heated material entered the mold while it was still plastically deformable. These systems are extremely large and expensive. Generally, they use large diameter pulley rollers that drive the mold belts to prevent the unnecessary bending of the mold belts around a small diameter pulley roller, which may cause cracking of the mold belts. These additional 3D mold machines are undesirable due to the added cost to operate and space required within the plant. In addition, this method requires an additional machine in the plastic extrusion process, which increases the risks of production downtime due to maintenance of this machine.

An exemplary embodiment of the present invention may overcome some or all of the shortcomings of the existing technology. One exemplary embodiment of the present invention is an integrated belt puller and 3D forming machine for forming 3D products from plastic materials. More particularly, the apparatus and method of the present invention provides a 3D belt puller for forming 3D products from plastic material. The belt puller may also facilitate cooling of the products. An exemplary embodiment of the present invention provides 3D forming using a single, compact, and economical apparatus. For example, one embodiment of the present invention is a standard belt puller in which the standard belts have been replaced with 3D mold belts, thus eliminating the need for an intermediate 3D mold machine as previously mentioned between the die system and the belt puller.

An exemplary embodiment of the integrated belt machine may comprise a belt puller that has upper and lower carriages. These carriages define an entry and an exit located at opposite ends of the machine. The upper and lower carriages may include two upper and two lower cylindrical, drum-shaped pulleys rotatably mounted respectively at the entry and exit ends of the upper carriage and at the entry and exit ends of the lower carriage.

The integrated belt puller and 3D forming machine may include a motor that drives the upper and lower pulleys at substantially the same speed. The 3D mold belts may be mounted on their respective carriages such that they may be removed and may revolve around the carriages. The upper and lower pulleys revolve the upper and lower mold belts in an opposed relationship around the respective upper and lower carriages. These revolving upper and lower mold belts define a moving 3D mold that is continuously moving from the entrance to the exit of the belt machine for continuously transforming a heated thermoplastic material having a 2D profile into a finished 3D product.

In addition to the novel features and advantages mentioned above, other features and advantages of the present invention will be readily apparent from the following descriptions of the drawings and exemplary embodiments.

### BRIEF DESCRIPTION OF THE DRAWINGS

FIG. 1 is a side elevation view of an exemplary embodiment of an integrated belt puller and 3D forming machine of the present invention.

FIG. 2 is a perspective view of the upper and lower mold belts of the integrated belt machine of FIG. 1.

FIG. 3 is a flow diagram of an exemplary plastic extrusion process including the integrated belt machine of FIG. 1.

FIG. 4 shows a side elevation view of an exemplary 3D finished product formed by the integrated belt machine of FIG. 1.

### DETAILED DESCRIPTION OF EXEMPLARY EMBODIMENT(S)

The present invention relates generally to a 3D belt forming machine. More particularly, the present invention is directed to an integrated belt puller and 3D forming machine (“integrated belt machine”) 10 for continuously forming 3D products from plastic materials. This integrated belt machine is both capable of pulling the heated plastic from the extruder while simultaneously imparting a 3D pattern into the thermoplastic material. The 3D formed products may have attractive 3D patterns and surface textures and may have a wide variety of useful configurations.

One exemplary embodiment of a 3D pattern that the integrated belt machine of the present invention can emboss is a brushed pattern. Another exemplary embodiment of the 3D pattern that the integrated belt machine can emboss is a surface with a quarter sawn pattern. The quarter sawn pattern may provide the look of top quality, vertical grain lumber. In addition, the quarter sawn pattern may provide a much desired alternative to the repetitive, v-shaped plain sawn pattern. Other patterns are also possible such as ornate patterns.

The types of products that may benefit from the present invention include various planks and railing components including, but not limited to, top rails, universal rails, balusters, post sleeves, and other railing components. Further products that may benefit from the present invention include siding, siding accessories, interior and exterior decorative house moldings and trim, picture frames, furniture components, deck components, deck railings, window moldings, window components, window lineals, door components, roof components, fence components, fence posts, fence rails, floor components, and other suitable indoor and outdoor items. In addition, the present invention may be used to manufacture other types of products that are commonly made from wood, composites, metal, or plastic.

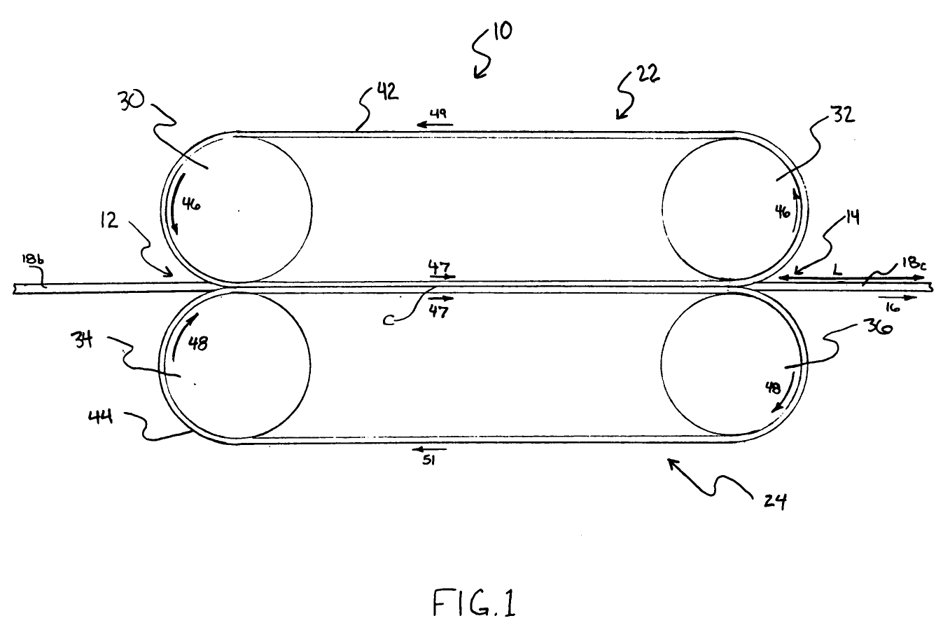

Referring to FIG. 1, the exemplary integrated belt machine 10 comprises a standard inline belt puller integrated with 3D mold belts 42 and 44 in a relatively small and inexpensive 3D forming machine for plastic materials. The puller may be any commonly known belt puller or any similar or equivalent machine. In an exemplary embodiment, the belt puller is a belt puller commercially available from Custom Downstream Systems, St-Laurent, Quebec, CA, or Extrusion Services, Inc., Akron, Ohio.

In the exemplary embodiment, the integrated belt machine 10 comprises an upper and lower belt carriage, 22 and 24, respectively. During operation of the integrated belt machine 10, upper and lower mold belt 42 and 44 are revolved in opposed relationship around the upper and lower carriages 22 and 24 respectively. The upper and lower mold belts 42 and 44 each travel in its own oval path around the respective carriages as shown by the motion arrows 46 and 48.

The generally oval paths around the upper and lower carriages 22 and 24 are established by pulley rolls located at an entrance end and exit end of each carriage. At an entrance end 12 of the belt machine 10 are upper and lower nip pulley rolls 30 and 34 located on the respective carriages. At the exit end 14 of the machine 10 are upper and lower pulley rolls 32 and 36 on the respective carriages. Each of these pulley rolls 30, 32, 34, and 36 spin on their own axles which may be movably mounted on standard bearings as common in the art. Preferably, the pulley rolls are less than 18 inches, more preferably less than 16 inches, much more preferably from about 2 inches to about 15 inches. One example of a pulley has a diameter of about 8 to about 10 inches. The belt puller may comprise one or more synchronized motors (not shown) to drive the pulley rolls of the upper and lower carriages at substantially the same speed. The operation of a belt puller is commonly known by those of ordinary skill in the art and need not be explained in detail in order to describe the present invention.

The upper and lower 3D mold belts 42 and 44 are revolved in opposite directions traveling along their respective upper and lower oval paths at about the same speed in an opposed face-to-face relationship for defining between them a traveling mold channel C. This mold channel C is continuously moving from the entrance 12 to the exit 14 of the integrated belt machine 10. Once at the exit 14, the 3D molt belts 42 and 44 separate from a 3D formed product 18c, which continues out from the exit end 14 of the integrated belt machine 10 as shown by arrow 16.

After the upper mold belt 42 has separated from the exiting product 18c, this upper mold belt travels around the upper exit pulley roll 32 as shown by the arrow 46, and then this upper mold belt returns toward the entrance 12 by traveling along a return travel path 49 moving toward the upper nip pulley roll 30. Upon reaching this nip pulley roll 30, the upper mold belt 42 travels around it as shown by the other arrow 46 and then moves into the entrance 12 to form the traveling mold channel C, thereby completing its revolution around its oval path. In summary, the upper oval path proceeds from entrance 12 along path 47 (for providing the traveling mold channel C) to exit 14 and then moves around upper exit pulley roll 32 and along path 49 back into the entrance 12.

After the lower mold belt 24 has separated from the exiting product 18c, this lower mold belt passes around the lower exit pulley roll 36 as shown by the arrow 48, and then this lower mold belt 24 returns toward the entrance 12 by traveling along a return travel path 51 moving toward the lower nip pulley roll 34. Upon reaching this lower nip pulley roll 34, the lower mold belt travels around this lower nip pulley 34 as shown by the other arrow 48 and then moves into the entrance 12 to form the traveling mold channel C, thereby completing its revolution around its oval path. In summary, the lower oval path proceeds from entrance 12 along path 47 (for providing the traveling mold channel C) to exit 14 and then moves around lower exit pulley roll 36 so as to travel along the return path 51 and then moves around lower entrance pulley roll 34 and into the entrance 12.

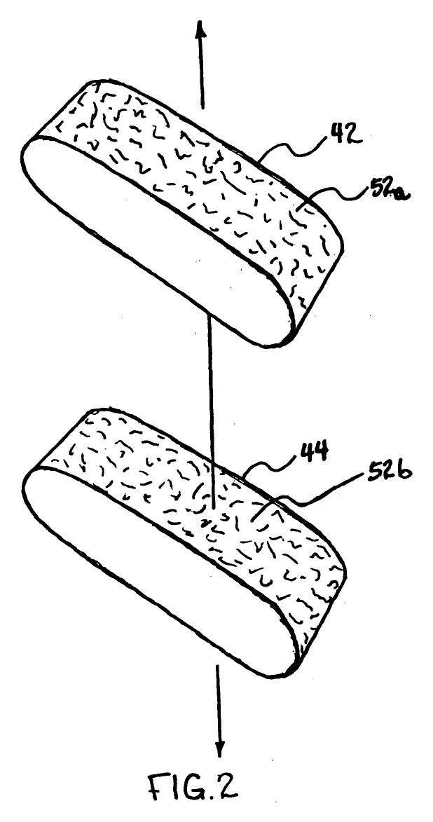

Referring to FIG. 2, the 3D upper mold belt 42 and the 3D lower mold belt 44 are shown. In an exemplary embodiment, these 3D belts 42 and 44 may be sized about or substantially the same as standard puller belts used in commercial belt puller machines (with the exception that the belts of the present invention have a varying height dimension as explained herein). One example of a 3D mold belt has a width of about 16 inches and a length of about 144 inches (i.e., 12 feet) for fitting an exemplary embodiment of a standard belt puller. Of course, the size of a 3D mold belt of the present invention may be selected in order to fit a particular standard belt puller. Because these 3D belts 42 and 44 may be sized to fit a belt puller, the circumferential lengths of the belts may be much smaller than known 3D forming belts. The belts may be made from materials capable of withstanding high temperatures, e.g., silicone rubber or other suitable materials.

The upper belt 42 may comprise a 3D pattern 52a embossed on its surface, and the lower belt 44 may comprise a 3D pattern 52b embossed on its surface. The lower belt's pattern 52b and the upper belt's pattern 52a may be the same, the opposite of each other (i.e., a mating relationship), or otherwise dissimilar (i.e., two different patterns). However, it should be recognized that one of the belts may not have a 3D pattern (i.e., only one of the belts would have a 3D pattern) in another exemplary embodiment of the present invention. In other words, a 3D product may still be produced even if only one of the belts is a 3D belt.

The 3D pattern may be adapted to simulate a variety of patterns, textures, wood grains, and other decorative styles. The mold pattern creates the variability in height (H) along the length (L) of the material. The variability in height (H) of the material is the result of the variability in depth (D) of the mold pattern. Preferably the depth (D) of the mold pattern may be up to about ⅛ inches or more, if desired. Examples of the belts 42 and 44 may be custom ordered from Kemco Plastics Corp., Mission Viejo, Calif.

The material formed into the finished 3D product may be made from any plastic material including, but not limited to, polymers, thermoplastics, thermosets, cellulosic-filled composites, inorganic-filled composites, and other types of material that are suitable for being embossed and/or molded. As compared to natural woods, a cellulosic-filled composite may offer superior resistance to wear and tear. For instance, a cellulosic-filled composite may have enhanced resistance to moisture. In fact, it is well known that the retention of moisture is a primary cause of the warping, splintering, and discoloration of natural woods. Moreover, a cellulosic-filled composite may be sawed, sanded, shaped, turned, fastened, and finished in a similar manner as natural wood.

A cellulosic-filled composite may be comprised of materials that include, but are not limited to, cellulosic fillers, polymers, inorganic fillers, cross-linking agents, lubricants, process aids, stabilizers, accelerators, inhibitors, enhancers, compatibilizers, blowing agents, foaming agents, thermosetting materials, pigments, anti-oxidants, and other suitable materials. Examples of cellulosic fillers include sawdust, newspapers, alfalfa, wheat pulp, wood chips, wood fibers, wood particles, ground wood, wood flour, wood flakes, wood veneers, wood laminates, paper, cardboard, straw, cotton, rice hulls, coconut shells, peanut shells, bagass, plant fibers, bamboo fiber, palm fiber, kenaf, flax, and other similar materials. In one exemplary embodiment of a material that may be formed using the present invention, the wood flour may have a mesh size between about 40 and about 60. In other exemplary embodiments, the wood flour may have smaller or larger mesh sizes. Wood flour may be selected from any desired type of wood including, but not limited to, oak and pine.

Examples of polymers include multilayer films, high density polyethylene (HDPE), low density polyethylene (LDPE), chlorinated polyethylene (CPE), polypropylene (PP), polyvinyl chloride (PVC), chlorinated polyvinyl chloride (CPVC), acrylonitrile butadiene styrene (ABS), ethyl-vinyl acetate (EVA), other similar copolymers, other similar, suitable, or conventional thermoplastic materials, and formulations that incorporate any of the aforementioned polymers. Examples of inorganic fillers include talc, calcium carbonate, kaolin clay, magnesium oxide, titanium dioxide, silica, mica, barium sulfate, and other similar, suitable, or conventional materials. Examples of cross-linking agents include polyurethanes, such as isocyanates, phenolic resins, unsaturated polyesters, epoxy resins, and other similar, suitable, or conventional materials. Combinations of the aforementioned materials are also examples of cross-linking agents.

Examples of lubricants include zinc stearate, calcium stearate, esters, amide wax, paraffin wax, ethylene bis-stearamide, and other similar, suitable, or conventional materials. Examples of stabilizers include light stabilizers, tin stabilizers, lead and metal soaps such as barium, cadmium, and zinc, and other similar, suitable, or conventional materials. In addition, examples of process aids include acrylic modifiers and other similar, suitable, or conventional materials. Examples of pigments include titanium dioxide and other similar or suitable white or color additives.

In one exemplary embodiment, the integrated belt machine 10 of the present invention may be used in a plastic extrusion process to form simulated wood products such as siding, fencing, decking, interior trim such as crown molding, exterior trim, or other products that may be molded from plastic material. Such plastics may include, but are not limited to, PVC, composite material such as cellulosic-filled and/or inorganic-filled plastic composite materials, or any other plastic material. The machine of the present invention combines a belt puller and three-dimension forming belts.

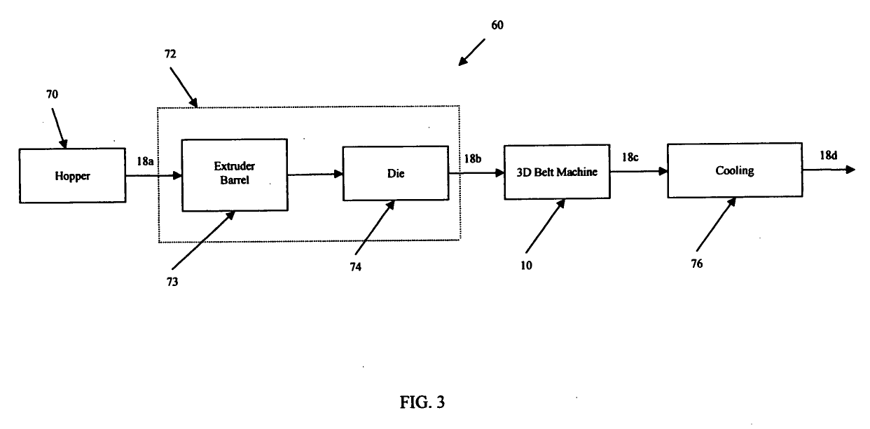

In an exemplary method of making a 3D product from a cellulosic composite material 18a using the integrated belt machine of the present invention as shown in FIG. 3, the cellulosic filler(s) may be dried to a desired moisture content. For example, the cellulosic filler(s) may be dried to a bout 0.5% to a bout 3% moisture content by weight, more preferably to about 1% to a bout 2% moisture content by weight. However, it is appreciated that the cellulosic filler(s) may have a moisture content less than about 0.5% by weight or greater than about 3% by weight. In addition, it should be recognized that an in-line compounding and extrusion system may be utilized to eliminate a pre-drying step.

Some or all of the composite ingredients may be combined in a mixer (not shown) prior to introduction into a molding apparatus 72 such as an extruder, a compression molding apparatus, an injection molding apparatus, or any other similar or suitable molding apparatus. Also, some or all of the ingredients may be separately introduced into the molding apparatus. One example of a mixer is a high intensity mixer such as those made by Littleford Day Inc. or Henschel Mixers America Inc. Another type of a mixer is a low intensity mixer including, but not limited to, a ribbon blender. The type of mixer may be selected to blend the ingredients at desired temperatures.

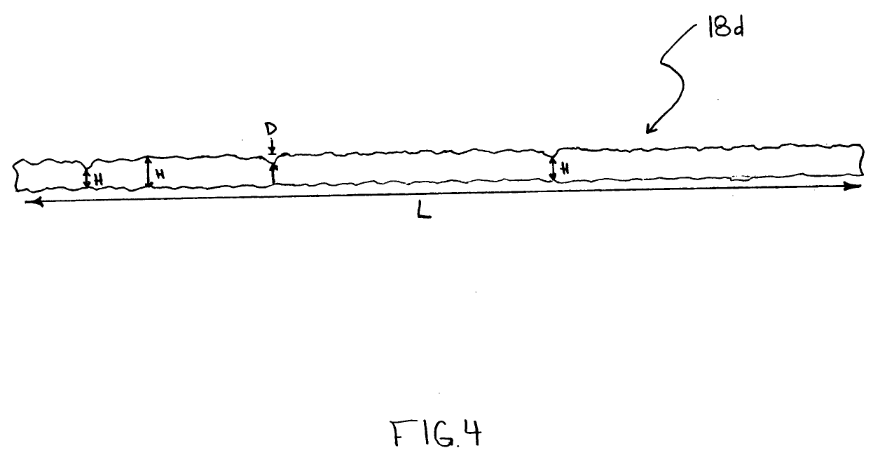

Preferably, the integrated belt machine 10 is used in conjunction with a plastic extrusion process 60 as is shown in FIG. 3. In this preferred process 60, the molding apparatus is an extrusion system 72 comprising a barrel 73 and a die 74 disposed at one end of the barrel. An example of an extruder is a conical, twin screw, counter-rotating extruder with a vent, which is commonly known in the art. At least one force feed hopper 70, crammer, or any other suitable, similar, or conventional apparatus may be used to feed the composite material 18a into the barrel 73 of the extrusion system 72. Inside the barrel 73, the material 18a is heated and then forced or extruded through at least one die 74. The die system 74 may include a fold-up die, a calibrator, a sizer, or any other similar or suitable equipment for making extruded products. The die 74 shapes the plastic material 18a into a continuous two-dimensional profile 18b such as a continuous piece of PVC siding. The die 74 may be used to give the product at least one embossed surface. However, the die 74 cannot provide an embossed surface that varies along the length (L) of the continuous 2D material 18b, i.e., it cannot form a 3D product as shown in FIG. 4.

After exiting the die system 74, the extruded product 18b may be cooled but is preferably fed into the entrance 12 of the integrated belt machine 10 of the present invention. As the material 18b moves through the mold channel C of the integrated belt machine 10, the upper and lower mold belts 42 and 44 impart a 3D pattern onto the 2D product 18b, providing variability in the height (H) along the length (L) of the product 18c (i.e., a 3D product). After the 3D formed product 18c leaves an exit 14 of the integrated belt machine 10, it may be cooled 76. For example, the extruded product 18c may be further cooled by submersing it in a liquid bath, passing it through a cooling liquid spray, and/or cooling it with compressed gas or cryogenic fluid. Once cooled, the 3D formed product 18c has been formed into the finished final product 18d. FIG. 4 shows the variability in the height (H) along the length (L) of the product 18d.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to affect the described invention. Many of those variations and modifications will provide the same result and fall within the spirit of the claimed invention. It is the intention, therefore, to limit the invention only as indicated by the scope of the claims.

What is claimed is:

1. A method for forming a cellulosic composite component, said method comprising:
providing a forming machine adjacent to a die of an extrusion system, said forming machine comprising:
a) first and second carriages;
b) a first mold belt having a 3D pattern provided on an outer surface, said first mold belt in association with said first carriage; and
c) a second mold belt in association with said second carriage;
d) wherein said first and second mold belts revolve in an opposed relationship around said respective first and second carriages, said first and second mold belts defining a moving 3D mold continuously moving from an entrance to an exit of said forming machine;
extruding a cellulosic composite material through said extrusion system; and
pulling said cellulosic composite material from said die with said forming machine such that said 3D mold forms a 3D pattern on a cellulosic composite component.

2. The method of claim 1, wherein said second mold belt comprises an outer surface having a 3D pattern.

3. The method of claim 2, wherein said 3D pattern of said second mold belt is adapted to have a mating relationship with said 3D pattern of said first mold belt.

4. The method of claim 1, wherein said first and second mold belts are comprised of silicone rubber.

5. The method of claim 1, wherein said first and second carriages are respectively comprised of first and second pulleys rotatably mounted, respectively, at an entry and exit end of said first carriage and at an entry and exit end of said second carriage.

6. The method of claim 5, wherein said pulleys of said first and second carriages have a diameter of less than 18 inches.

7. The method of claim 6, wherein said pulleys of said first and second carriages have a diameter of less than 16 inches.

8. The method of claim 7, wherein said pulleys of said first and second carriages have a diameter from about 2 inches to about 15 inches.

9. The method of claim 1, wherein said 3D pattern creates variability in height along a length of said cellulosic composite component.

10. The method of claim 1, wherein said 3D pattern is a simulated wood grain.

11. The method of claim 1, wherein said 3D pattern is a brushed pattern.

12. The method of claim 1, wherein said 3D pattern is a plain sawn pattern.

13. The method of claim 1, wherein said 3D pattern is a quarter sawn pattern.

14. The method of claim 1, wherein said forming machine is adapted to provide said cellulosic composite component to a cooling system.

15. A method for forming a cellulosic composite component, said method comprising:
providing a forming machine adjacent to a die of an extrusion system, said forming machine comprising:
a) upper and lower carriages defining an entry and an exit located at opposite ends of said forming machine, said upper carriage having two upper pulleys respectively and rotatably mounted at said entry and exit ends of said upper carriage, said lower carriage having two lower pulleys respectively and rotatably mounted at said entry and exit ends of said lower carriage;
b) a motor driving said upper and lower pulleys at synchronized speed;
c) an upper mold belt having a 3D pattern provided on an outer surface, said upper mold belt revolvably mounted on said upper carriage; and
d) a lower mold belt revolvably mounted on said lower carriage;
e) wherein said upper and lower pulleys revolve said upper and lower mold belts in an opposed relationship around said respective upper and lower carriages, said upper and lower mold belts defining a 3D mold continuously moving from said entry to said exit of said forming machine;
extruding a cellulosic composite material through said extrusion system; and
pulling said cellulosic composite material from said die with said forming machine such that said 3D mold forms a 3D pattern on a cellulosic composite component.

16. The method of claim 15, wherein said lower mold belt comprises an outer surface having a 3D pattern.

17. The method of claim 15, wherein said upper and lower mold belts are comprised of silicone rubber.

18. The method of claim 15, wherein said upper and lower pulleys of said upper and lower carriages have a diameter of less than 18 inches.

19. The method of claim 18, wherein said upper and lower pulleys of said upper and lower carriages have a diameter of less than 16 inches.

20. A method for forming a cellulosic composite component, said method comprising:
providing at least one feeder to supply cellulosic composite ingredients;
supplying said cellulosic composite ingredients to an extrusion system;
extruding a cellulosic composite material through said extrusion system; and
pulling said cellulosic composite material from said die with a forming machine, said forming machine comprising:
a) first and second carriages;
b) a first mold belt having a 3D pattern provided on an outer surface, said first mold belt in association with said first carriage; and
c) a second mold belt in association with said second carriage;
d) wherein said first and second mold belts revolve in an opposed relationship around said respective first and second carriages, said first and second mold belts defining a moving 3D mold continuously moving from an entrance to an exit of said forming machine;
wherein said 3D mold forms a 3D pattern on a cellulosic composite component.
